(19) United States
(12) Patent Application Publication
(10) Pub. No.: US 2007/0091342 A1
(43) Pub. Date: Apr. 26, 2007

(54) Image forming device and control method for image forming device

(76) Inventor: Sachiko Yoshimura, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,080

(22) Filed: Oct. 26, 2005

(51) Int. Cl. G06F 3/12

(52) U.S. Cl. 358/1.13; 358/1.18

(57) ABSTRACT

A printing unit 13, and a control unit 1 for controlling the printing unit so as to print document images on the same face of printing paper sheets for a necessary number of printing paper sheets, on a printing region partitioned beforehand, following a pre-established printing order from a first to a last page of a document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document.

### FIELD OF THE INVENTION

The present invention relates to an image forming device and a control method for an image forming device in copiers, fax devices, printers, or multi-function devices, and the like incorporating two or more of the foregoing.

### BACKGROUND INFORMATION

Some conventional image forming devices have a combined printing function whereby a plurality of document images are printed on the same face of one printing paper sheet. In such a conventional image forming device, when for instance five copies of three documents a, b and c are to be copied, combined printing is performed by printing two pages of each document on the same face of one printing paper sheet, as illustrated in FIG. 5; once copying is over, some such conventional image forming devices have a function whereby the printing paper sheets, cut along the broken lines and stacked in blocks, can be sorted into five copies by page order.

Combined printing in FIG. 5 involves copying five copies of three documents a, b, and c on the same face of a printing paper sheet, with two pages of the same document printed on one printing paper sheet, while in FIG. 6, the same face of one printing paper sheet is divided into 2 printing regions such that the document images are printed in the order of documents a, b, c, a, b, c . . . on a first printing region in a plurality of printing paper sheets; the conventional image forming device has herein a function whereby upon printing the last page of the printing paper sheets, printing continues on a second printing region back on the initial page. The above conventional image forming devices, however, had a problem in that, although print copies of a combined-printed product can be sorted by page order, they do not allow sorting the printed product into groups by sorting the print copies of each document page into one set (group).

Some conventional image forming devices have a combined printing function whereby a plurality of document images are printed on the same face, or both faces, of one printing paper sheet. In such a conventional image forming device, when for instance five copies of three documents a, b and c are to be copied, combined printing is performed by printing two pages of each document on the same face of one printing paper sheet, as illustrated in FIGS. 13 and 14; once copying is over, some such conventional image forming devices have a function whereby the printing paper sheets, cut along the broken lines and stacked in blocks, can be sorted into five copies by page order.

Combined printing in FIG. 13 involves copying five copies of three documents a, b, and c on the same face of a printing paper sheet, with two pages of the same document printed on one printing paper sheet, while in FIG. 14, the same face of one printing paper sheet is divided into 2 printing regions such that the document images are printed in the order of documents a, b, c, a, b, c . . . on a first printing region in a plurality of printing paper sheets; the conventional image forming device has herein a function whereby upon printing the last page of the printing paper sheets, printing continues on a second printing region back on the initial page.

Image forming devices have been proposed having a combined printing function for document images wherein two documents are printed on a single face of, or 4 documents are printed on both faces of, one printing paper sheet. FIG. 15 shows an instance of a printing operation in which 8 documents a through h are printed, one copy per document, on two printing paper sheets, so that documents images a, b are printed on the front of a first printing paper sheet, the printing paper sheet is then flipped to print document images c, d on the back thereof, then documents images e, f are printed on the front of a second printing paper sheet, and the printing paper sheet is then flipped to print document images g, h on the back thereof.

FIG. 16 shows an instance of a printing operation in which one copy of each of eight documents a through h are printed on printing regions of printing paper sheets in a predetermined order such that a booklet is formed with the document images in the order of a, b, c, . . . , h upon folding back the printing paper sheets along the broken lines in the center of the printing paper sheets for partitioning the printing regions thereof.

The above conventional image forming devices, however, had a problem in that, when a plurality of image documents are combined-printed on both sides of one printing paper sheet, the documents cannot be sorted by page order.

In light of the above, it is an object of the present invention to provide an image forming device and a control method for an image forming device that allows sorting a combined-printed printed product into groups by sorting into one set (group) the print copies of each document page.

In light of the above, also, it is an object of the present invention to provide an image forming device and a control method for an image forming device that allows sorting by document page order a plurality of document images combined-printed on both faces of one printing paper sheet.

### SUMMARY OF THE INVENTION

To achieve the above goals, the invention recited in claim 1 is an image forming device having a combined printing function for printing a plurality of document images on a same face of one printing paper sheet, comprising: printing means for printing document images acquired by document reading in accordance with a number of documents and a number of print copies; and control means for calculating a number of necessary printing paper sheets on the basis of the number of documents, the number of print copies, and a number of document images for combined printing on one printing paper sheet, and for controlling the printing means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document.

Also, the invention recited in claim 2 is an image forming device having a combined printing function for printing a plurality of document images on a same face of one printing paper sheet, comprising input means for designating settings such as number of document print copies, printing paper size, printing mode or the like, and for instructing among others a start of a printing operation; counting means for counting the number of set documents; document reading means for reading document images; image data storing means for storing document image data read by the document reading means; printing means for reading the document image data from the image data storing means and for printing the document image data on printing paper; computation means for, if the set printing mode when printing is instructed by the input means is a combined printing mode, computing the number of printing paper sheets on the basis of the number of documents counted by the counting means, the number of print copies set by the input means, and a number of document images for combined printing on one printing paper sheet; and control means for controlling the printing means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document.

Also, the invention recited in claim 3 is an image forming device according to claim 2, wherein the computation means calculates the necessary number of printing paper sheets Q as Q=M×N/K, if M×N is even (M×N being an integer ≧2), and Q={the quotient of (M×N/K)}+1, if M×N is odd, wherein M is a number of documents, N is a number of print copies, and K is a number (an even number ≧2) of document images for combined printing on the same face of one printing paper sheet, and wherein if M×N is odd, the control means controls the printing means so as to leave (K-L) blank printing regions on the last page of the printing paper sheets after printing all the print copies of the document images, L being the remainder of M×N/K.

Also, the invention recited in claim 4 is an image forming device according to claim 2, having a selectable first printing mode in which, when combined printing is set as the printing mode, combined printing is carried out by consecutively printing the number of print copies for each page of the document on one printing region among a plurality thereof into which one face of one printing paper sheet is divided, in a number of printing paper sheets according to the number of document print copies; and having a selectable second printing mode in which combined printing is consecutively carried out on all the pages of the document, in the page order of the document, as 1 set, for the number of print copies (number of sets), on one printing region among a plurality thereof into which one face of one printing paper sheet is divided, in a number of printing paper sheets according to the number of document print copies.

Also, the invention recited in claim 5 is a control method for an image forming device having a combined printing function for printing a plurality of document images on a same face of one printing paper sheet, comprising the steps of: calculating a number of necessary printing paper sheets on the basis of the number of documents, the number of print copies, and a number of document images for combined printing on one printing paper sheet; printing the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies; and continuing printing on another printing region, being a next printing region in a printing sequence, if by a last page of the printing paper sheets there remain not enough printing paper sheets for printing the number of print copies of a same document image, returning to the first page of the printing paper sheets to print the number of copies of the document images of the last page of the document.

Also, the invention recited in claim 6 is a control method for an image forming device having a combined printing function for printing a plurality of document images on a same face of one printing paper sheet, comprising the steps of: inputting settings such as number of document print copies, printing paper size, printing mode or the like, and for instructing among others a start of a printing operation, by way of input means; counting the number of set documents by way of counting means; reading document images by way of document reading means; storing document image data read by the document reading means by way of image data storing means; calculating the number of printing paper sheets on the basis of the number of documents counted by the counting means, the number of print copies set by the input means, and a number of document images for combined printing on one printing paper sheet, if the set printing mode when printing is instructed by the input means is a combined printing mode; calculating, by way of computation means, the number of printing paper sheets on the basis of the number of documents counted by the counting means, the number of print copies set by the input means, and a number of document images for combined printing on one printing paper sheet, if the set printing mode when printing is instructed by the input means is a combined printing mode; and controlling the printing means by way of control means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, and so as to continue printing on another printing region, being a next printing region in a printing sequence, if by a last page of the printing paper sheets there remain not enough printing paper sheets for printing the number of print copies of a same document image, returning to the first page of the printing paper sheets to print the number of copies of the document images of the last page of the document.

Also, the invention recited in claim 7 is a control method for an image forming device according to claim 6, wherein the computation means calculates the necessary number of printing paper sheets Q as Q=M×N/K, if M×N is even (M×N being an integer ≧2), and Q={the quotient of (M×N/K)}+1, if M×N is odd, wherein M is a number of documents, N is a number of print copies, and K is a number (an even number ≧2) of document images for combined printing on the same face of one printing paper sheet; and wherein if M×N is odd, the control means controls the printing means so as to leave (K-L) blank printing regions on the last page of the printing paper sheets after printing all the print copies of the document images, L being the remainder of M×N/K.

Thus, the image forming device and control method for an image forming device according to the present invention have the effect of allowing sorting a printed product of combined-printing into groups by sorting the print copies of each document page into one set (group).

To achieve the above goals, also, the invention recited in claim 8 is an image forming device having a combined printing function for printing a plurality of document images on both faces of one printing paper sheet, comprising printing means for printing document images acquired by document reading in accordance with a number of documents and a number of print copies; and control means for calculating a number of necessary printing paper sheets on the basis of the number of documents, the number of print copies, and a number of document images for combined printing on one printing paper sheet, and for controlling the printing means so as to repeatedly and sequentially print document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, wherein upon reaching a last page of the plurality of printing paper sheets, printing continues returning to the first page of the plurality of printing paper sheets, on a next printing region in a printing order, until printing the number of copies of the plurality of document images, for each printing region of the plurality thereof.

Also, the invention recited in claim 9 is an image forming device having a combined printing function for printing a plurality of document images on both faces of one printing paper sheet, comprising input means for designating settings such as number of document print copies, printing paper size, printing mode or the like, and for instructing among others a start of a printing operation; counting means for counting the number of set documents; document reading means for reading document images; image data storing means for storing document image data read by the document reading means; printing means for reading the document image data from the image data storing means and for printing the document image data on printing paper; computation means for, if the set printing mode when printing is instructed by the input means is a combined printing mode, computing the number of printing paper sheets on the basis of the number of documents counted by the counting means, the number of print copies set by the input means, and a number of document images for combined printing on one printing paper sheet; and control means for controlling the printing means so as to repeatedly and sequentially print document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, wherein upon reaching a last page of the plurality of printing paper sheets, printing continues returning to the first page of the plurality of printing paper sheets, on a next printing region in a printing order, until printing the number of copies of the plurality of document images, for each printing region of the plurality thereof.

Also, the invention recited in claim 10 is an image forming device according to claim 9, wherein the computation means calculates the necessary number of printing paper sheets Q as Q=M×N/2K (if divisible) or Q={the quotient of (M×N/2K)}+1 when M is even, and as Q=(M+1)×N/2K (if divisible) or Q={the quotient of (M+1)×N/K)}+1 when M is odd, M being a number of documents (an integer ≧2), N a number of print copies (an integer ≧2), and K a number (an even number ≧2) of document images for combined printing on the same face of one printing paper sheet, and wherein when M is odd, the control means controls the printing means so as to leave blank the printing region of a (M+1)th page following M pages where document images of each document have been printed on the printing paper sheets.

Also, the invention recited in claim 11 is a control method for an image forming device having a combined printing function for printing a plurality of document images on both faces of one printing paper sheet, comprising the steps of: calculating a number of necessary printing paper sheets on the basis of the number of documents, the number of print copies, and a number of document images for combined printing on one printing paper sheet; repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand; and continuing printing, upon reaching the last page of the plurality of printing paper sheets, returning to the first page of the plurality of printing paper sheets, on a next printing region in a printing order, until printing the number of print copies of the plurality of document images, for each printing region of the plurality thereof.

Also, the invention recited in claim 12 is a control method for an image forming device having a combined printing function for printing a plurality of document images on the same face of one printing paper sheet, comprising the steps of: inputting settings such as number of document print copies, printing paper size, printing mode or the like, and for instructing among others a start of a printing operation, by way of input means; counting the number of set documents by way of counting means; reading document images by way of document reading means; storing document image data read by the document reading means by way of an image data storing means; calculating, by way of computation means, the number of printing paper sheets on the basis of the number of documents counted by the counting means, the number of print copies set by the input means, and a number of document images for combined printing on one printing paper sheet, if the set printing mode when printing is instructed by the input means is a combined printing mode; and controlling the printing means by way of control means so as to repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, and so as to continue printing, upon reaching the last page of the plurality of printing paper sheets, returning to the first page of the plurality of printing paper sheets, on a next printing region in a printing order, until printing the number of copies of the plurality of document images, for each printing region of the plurality thereof.

Also, the invention recited in claim 13 is a control method for an image forming device according to claim 12, wherein the computation means calculates the necessary number of printing paper sheets Q as Q=M×N/2K (if divisible) or Q={the quotient of (M×N/2K)}+1 when M is even, and as Q=(M+1)×N/2K (if divisible) or Q={the quotient of (M+1)×N/K)}+1 when M is odd, M being a number of documents (an integer ≧2), N a number of print copies (an integer ≧2), and K a number (an even number ≧2) of document images for combined printing on the same face of one printing paper sheet; and wherein when M is odd, the control means controls the printing means so as to leave blank the printing region of a (M+1)th page following M pages where document images of each document have been printed on the printing paper sheets.

Thus, the image forming device and control method for an image forming device according to the present invention have the effect of allowing sorting by document page order a plurality of document images combined-printed on both faces of one printing paper sheet.

### BRIEF DESCRIPTION OF THE DRAWINGS

FIG. 1 is a block diagram illustrating the constitution of an image forming device according to a first embodiment of the present invention.

FIG. 2 is a flow chart illustrating the printing operation of an image forming device according to a first embodiment of the present invention.

FIG. 3 is a flow chart illustrating the printing operation of an image forming device according to a first embodiment of the present invention.

FIG. 4 is an explanatory diagram illustrating combined printing being carried out by an image forming device according to a first embodiment of the present invention.

FIG. 5 is an explanatory diagram illustrating combined printing being carried out by a conventional image forming device.

FIG. 6 is an explanatory diagram illustrating combined printing being carried out by a conventional image forming device.

FIG. 7 is a block diagram illustrating the constitution of an image forming device according to a second embodiment of the present invention.

FIG. 8 is a flow chart illustrating the printing operation of an image forming device according to a second embodiment of the present invention.

FIG. 9 is a flow chart illustrating the printing operation of an image forming device according to a second embodiment of the present invention.

FIG. 10 is a flow chart illustrating the printing operation of an image forming device according to a second embodiment of the present invention.

FIG. 11 is an explanatory diagram illustrating an example of combined printing being carried out by an image forming device according to a second embodiment of the present invention.

FIG. 12 is an explanatory diagram illustrating another example of combined printing being carried out by an image forming device according to a second embodiment of the present invention.

FIG. 13 is an explanatory diagram illustrating an example of combined printing being carried out by a conventional image forming device.

FIG. 14 is an explanatory diagram illustrating an example of combined printing being carried out by a conventional image forming device.

FIG. 15 is an explanatory diagram illustrating another example of combined printing being carried out by a conventional image forming device.

FIG. 16 is an explanatory diagram illustrating another example of combined printing being carried out by a conventional image forming device.

### DETAILED DESCRIPTION OF THE PREFERRED EMBODIMENTS

First Embodiment

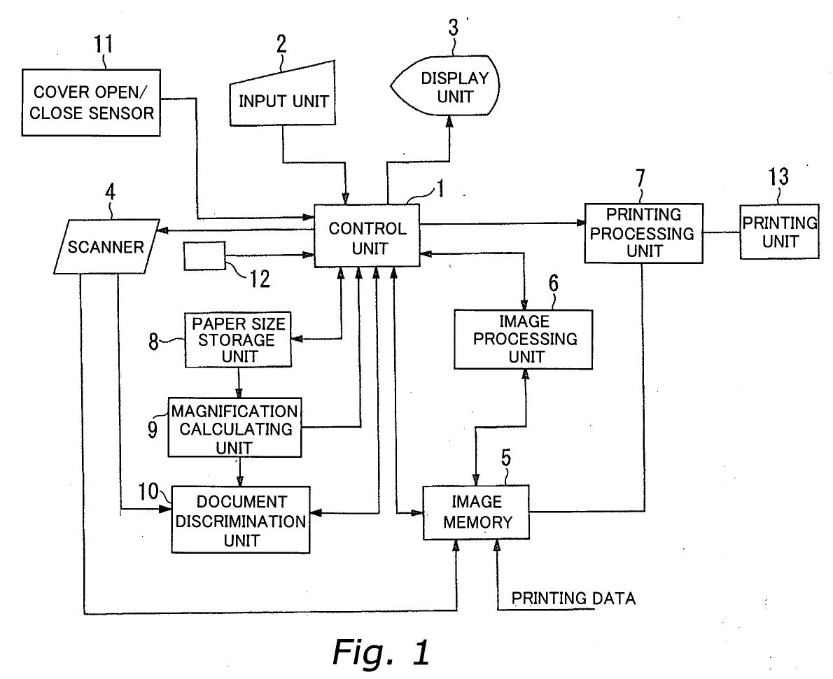

A first embodiment of the present invention will be described next while referring to accompanying drawings. FIG. 1 illustrates the constitution of an image forming device in a first embodiment of the present invention. In the figure, the image forming device according to the present embodiment has a control unit 1, an input unit 2, a display unit 3, a scanner 4, an image memory 5, an image processing unit 6, a printing processing unit 7, a paper size storage unit 8, a magnification calculating unit 9, a document discrimination unit 10, a cover open/close sensor 11, a document number counter 12, and a printing unit 13. The cover open/close sensor 11 is a sensor for detecting the open/close state of a cover on the chassis of the image forming device.

The input unit 2 has, among others, a function key for selecting fax, copier, and printer functions, a cursor key for designating functions such as setting of various printing modes including a combined printing mode, a numeric keypad for inputting numerical data designating the number of printing runs, the number of copies and the like, and a power key for turning power on and off. The input unit 2 corresponds to the inputting means of the present invention.

In the display unit 3 are displayed various screens and messages such as indications, instructions, etc., resulting from the operation of the keys in the input unit 2.

The scanner 4 reads documents placed on a platen, not shown in the figures, and outputs the image information of the documents converted into digital data (document image data). The scanner 4 corresponds to the document reading means of the present invention.

The image memory 5 stores the document image data output by the scanner 4 or printing data input externally.

Once recorded in the image memory 5, the data are read and, under the control of the control unit 1, are subjected to a predetermined image processing, such as data compression or the like, by the image processing unit 6, after which the data are stored again in the image memory 5. The image memory 5 corresponds to the image data storing means of the present invention.

The document number counter 12 is a counter for counting the number of documents to be printed placed on a platen not shown in the figures, and corresponds to the counting means of the present invention.

The printing unit 13 prints on printing paper the document image data read by the scanner 4. The printing unit 13 corresponds to the printing means of the present invention.

The scanner 4 inputs into the document discrimination unit 10 data indicating the size of the document read by that scanner 4.

On the basis of the size of paper held on a cassette, as read by the paper size storage unit 8, and the document size output by the document discrimination unit 10, the magnification calculating unit 9 calculates the magnification with which an indeterminate-shaped paper held on the cassette is to be printed, and outputs that magnification to the control unit 1.

The control unit 1 instructs the image memory 5 to output image data to the printing processing unit 7 and indicates to the printing processing unit 7 the printing magnification output by the magnification calculating unit 9.

As a result, the printing processing unit 7 reads the image data output by the image memory 5, performs printing processing with the printing magnification indicated by the control unit 1, and instructs the printing unit 13 to carry out printing.

If the set printing mode is a combined printing mode, the control unit 1 calculates the number of printing paper sheets on the basis of the number of documents counted by the document number counter 12, the number of print copies set by the input unit 2, and the number of document images for combined printing on one printing paper sheet.

The control unit 1 has the function of controlling the printing unit 13 via the printing processing unit 7 so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document. The control unit 1 corresponds to the computation means and control means of the present invention.

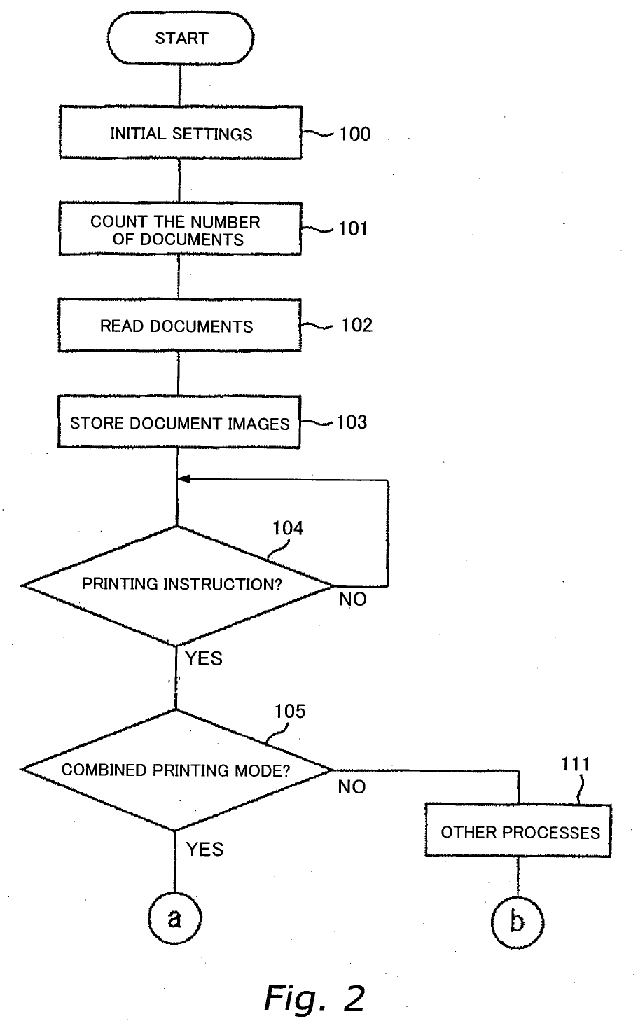

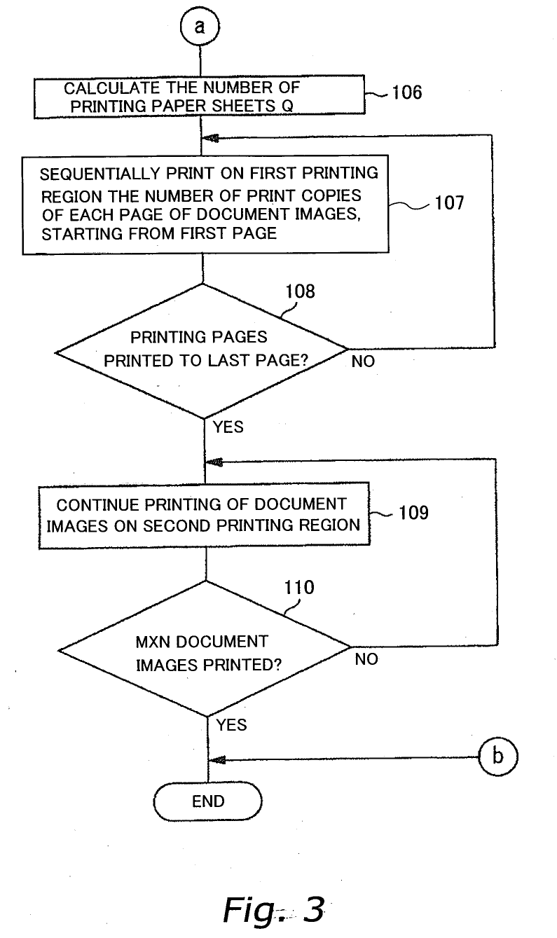

The operation of the image forming device according to the first embodiment of the present invention is explained next with reference to the flowcharts of FIG. 2 and FIG. 3. Operations in the constitution of FIG. 1 that have no direct connection with the present invention will not be explained herein. In these figures, the input unit 2 sets first the number of print copies of the documents, the printing paper size, the printing mode etc., as default settings, and instructs among others the start of the printing operation (Step 100), whereupon the document number counter 12 counts the number of documents placed on a platen not shown in the figure (Step 101).

Next, the document is read by the scanner 4 and is converted into digital document image data (Step 102); the document image data is then stored in the image memory 5 (Step 103). Next it is determined whether the input unit 2 has instructed printing or not (Step 104). If NO in Step 104, the same assessment is repeated. If YES in Step 104, it is then determined whether the designated printing mode is a combined printing mode or not (Step 105).

If NO in Step 105, other processes are performed (processes other than combined printing), (Step 111), and the printing operation is terminated.

If YES in Step 105, the number of printing paper sheets Q is then calculated on the basis of the number of documents M counted by the document number counter 12, the number of print copies N set by the input unit 2, and the number K of document images for combined printing on one printing paper sheet (Step 106).

Taking Q as the necessary number of printing paper sheets, the number of printing paper sheets Q is calculated as Q=M×N/K, if M×N is even (M×N being an integer ≧2), and Q={the quotient of (M×N/K)}+1, if M×N is odd, wherein M is the number of documents, N is the number of print copies, and K is the number (an even number ≧2) of document images for combined printing on the same face of one printing paper sheet.

In the present embodiment, the number K of document images for combined printing on the same face of one printing paper sheet is set to K=2, so that one sheet of printing paper is divided into two printing regions, a first printing region and a second printing region.

By way of example, let us assume that five copies of three documents a, b and c are to be combined-printed. In this case, M=3, N=5, and K=2; thus M×N=15 (odd), so the number of printing paper sheets Q becomes Q=8.

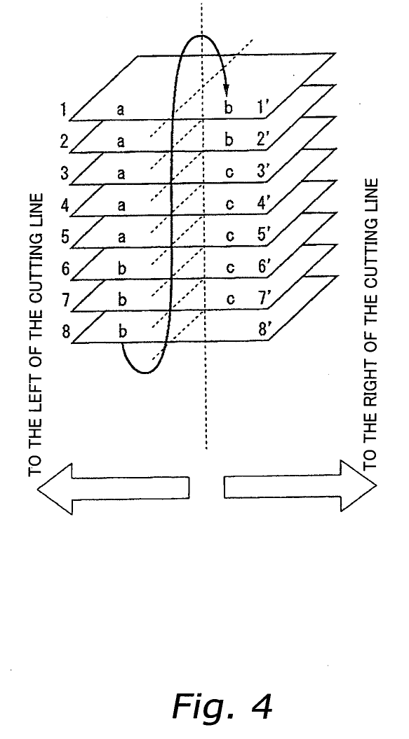

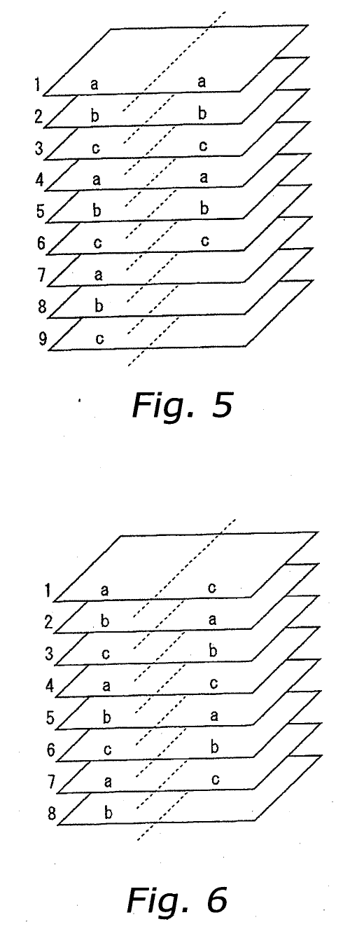

After calculating the number of printing paper sheets Q, the document images are printed on a first printing region P1 on the same face of the printing paper sheets, each page printed for the given number of print copies, in the order starting from the first page of the document images, as shown in FIG. 4 (Step 107). That is, the first page a of the document images is printed on five pages of the printing paper sheets 1 to 5, 5 being the number of print copies; then printing continues with five pages of the document image b, the next page, which are printed starting from the printing paper sheet 6.

The process determines then whether printing has been completed up to the last page of the number of printing paper sheets as calculated in Step 106 (Step 108). If NO in Step 108, the process returns to Step 107 to carry out the processing already described.

If YES in Step 108, printing of the document images continues on the second printing region P2 back on the first page of the printing paper sheets (Step 109). In the present embodiment, five pages of the second page of the document image are printed starting from the printing paper sheet 6; in combined printing, only three pages can be printed up to the last page of the printing paper, the printing paper sheet 8, so the printing of the five pages of document image b continues on the printing region P2 back on the first page of the printing paper sheets. Printing goes on then in the same way for the next document image c.

Next, the process determines whether M×N document images have been printed in the combined printing of the document images (Step 110). If NO in Step 110, the process returns to Step 109, to carry out the processing already described. If YES in step 110, the printing operation ends. Herein, if the number of document images M×N is odd, the control unit 1 controls the printing unit 13 so as to leave (K-L) blank printing regions on the last page of the printing paper sheets after printing all the print copies of the document images, L being the remainder of M×N/K. In the above example, this means that K-L=2−1=1 printing region P2 is left blank in the last page of the printing paper sheets, since M×N=3×5 is an odd number.

Once the above printing is over, the printed paper sheets are cut along the broken lines indicated by the arrow in FIG. 4, using auxiliary equipment of the image forming device, so as to separate the printing regions P1 and P2; the document images a, b, c can then be automatically sorted as five copies each of printing paper sheets 1.2.3.4.5(aaaaa)→6.7.8.1′.2′(bbbbb)→3′.4′.5′.6′.7′(ccccc) by stacking the cut printing paper sheets 1 through 8 of the left onto the cut printing paper sheets 1′ through 7′ of the right. The cutting and stacking of the printed product can also be done by the user.

When, in the present embodiment, combined printing is set as the printing mode, combined printing is carried out by consecutively printing the number of print copies for each page of the document on one printing region among a plurality thereof into which one face of one printing paper sheet is divided, in a number of printing paper sheets according to the number of document print copies; alternatively, however, the embodiment may also be constituted having an optional second printing mode in which combined printing is conventionally carried out by consecutively printing all the pages of the document, in the page order of the document, as 1 set, for the number of print copies (number of sets), on one printing region among a plurality thereof into which one face of one printing paper sheet is divided, in a number of printing paper sheets according to the number of document print copies.

Second Embodiment

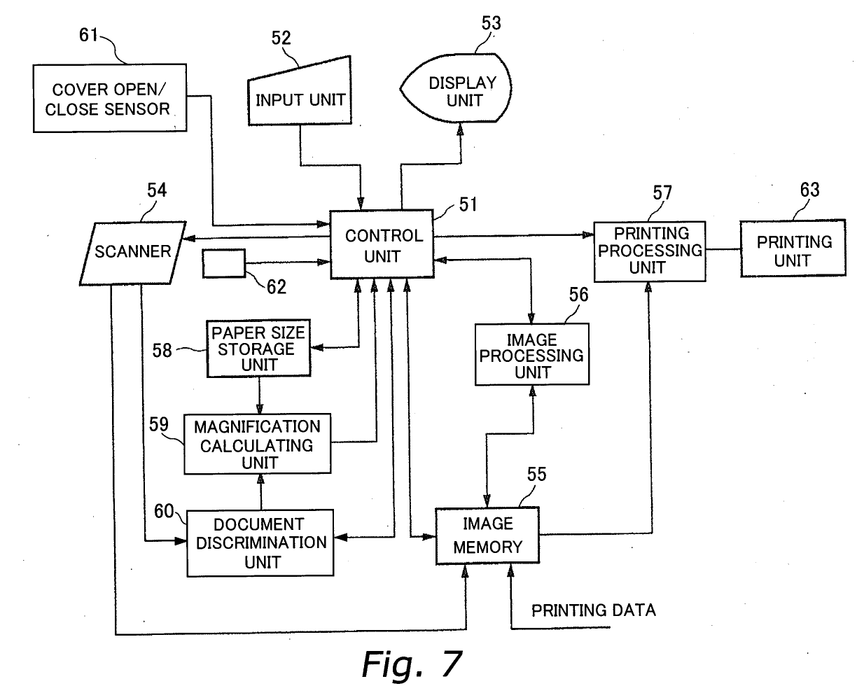

A second embodiment of the present invention will be described next while referring to accompanying drawings. FIG. 7 illustrates the constitution of an image forming device in a second embodiment of the present invention. In the figure, the image forming device according to the present embodiment has a control unit 51, an input unit 52, a display unit 53, a scanner 54, an image memory 55, an image processing unit 56, a printing processing unit 57, a paper size storage unit 58, a magnification calculating unit 59, a document discrimination unit 60, a cover open/close sensor 61, a document number counter 62, and a printing unit 63. The cover open/close sensor 61 is a sensor for detecting the open/close state of a cover in the chassis of the image forming device.

The input unit 52 has, among others, a function key for selecting fax, copier, and printer functions, a cursor key for designating functions such as setting and the like of various printing modes including a combined printing mode, a numeric keypad for inputting numerical data designating the number of printing runs, the number of copies and the like, and a power key for turning power on and off. The input unit 52 corresponds to the inputting means of the present invention.

In the display unit 53 are displayed various screens and messages such as indications, instructions, etc., resulting from the operation of the keys in the input unit 52.

The scanner 54 reads documents placed on a platen, not shown in the figures, and outputs the image information of the documents converted into digital data (document image data). The scanner 54 corresponds to the document reading means of the present invention.

The image memory 55 stores the document image data output by the scanner 54 or printing data input externally.

Once recorded in the image memory 55, and under the control of the control unit 51, the data are read and are subjected to a predetermined image processing, such as data compression or the like, by the image processing unit 56, after which the data are stored again in the image memory 55. The image memory 55 corresponds to the image data storing means of the present invention.

The document number counter 62 is a counter for counting the number of documents to be printed placed on a platen not shown in the figures, and corresponds to the counting means of the present invention.

The printing unit 63 prints on printing paper the document image data read by the scanner 54. The printing unit 63 corresponds to the printing means of the present invention.

The scanner 54 inputs into the document discrimination unit 60 data indicating the size of the document read by that scanner 54.

On the basis of the size of paper held on a cassette, as read by the paper size storage unit 58, and the document size output by the document discrimination unit 60, the magnification calculating unit 59 calculates the magnification with which an indeterminate-shaped paper held on the cassette is to be printed, and outputs the result to the control unit 51.

The control unit 51 instructs the image memory 55 to output image data to the printing processing unit 57 and indicates to the printing processing unit 57 the printing magnification output by the magnification calculating unit 59.

As a result, the printing processing unit 57 reads the image data output by the image memory 55, performs printing processing with the printing magnification indicated by the control unit 51, and instructs the printing unit 63 to carry out printing.

If the set printing mode is a combined printing mode, the control unit 51 calculates the number of printing paper sheets on the basis of the number of documents counted by the document number counter 62, the number of print copies set by the input unit 52, and the number of document images to be combined-printed on 1 sheet of printing paper.

The control unit 51 has the function of controlling the printing unit 63 via the printing processing unit 57 so as to repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, wherein upon reaching a last page of the plurality of printing paper sheets, printing continues returning to the first page of the plurality of printing paper sheets, on a next printing region in a printing order, until printing the number of copies of the plurality of document images, for each printing region of the plurality thereof. The control unit 51 corresponds to the computation means and control means of the present invention.

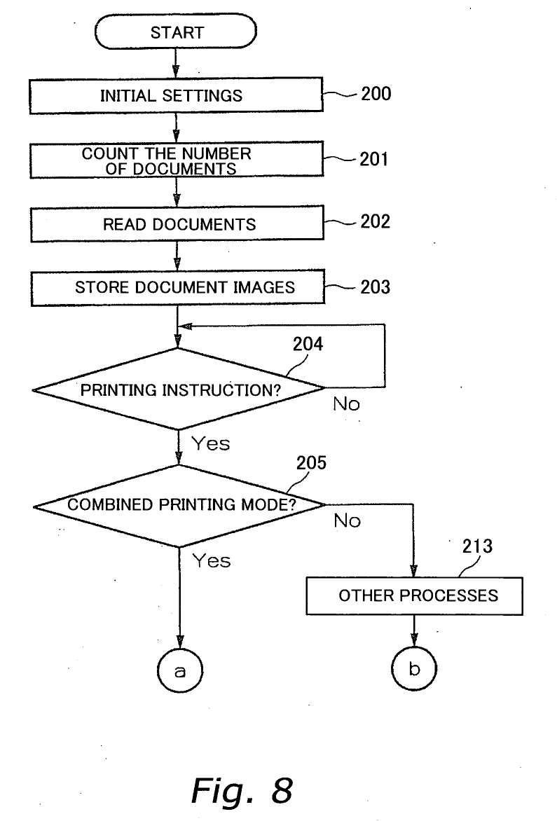

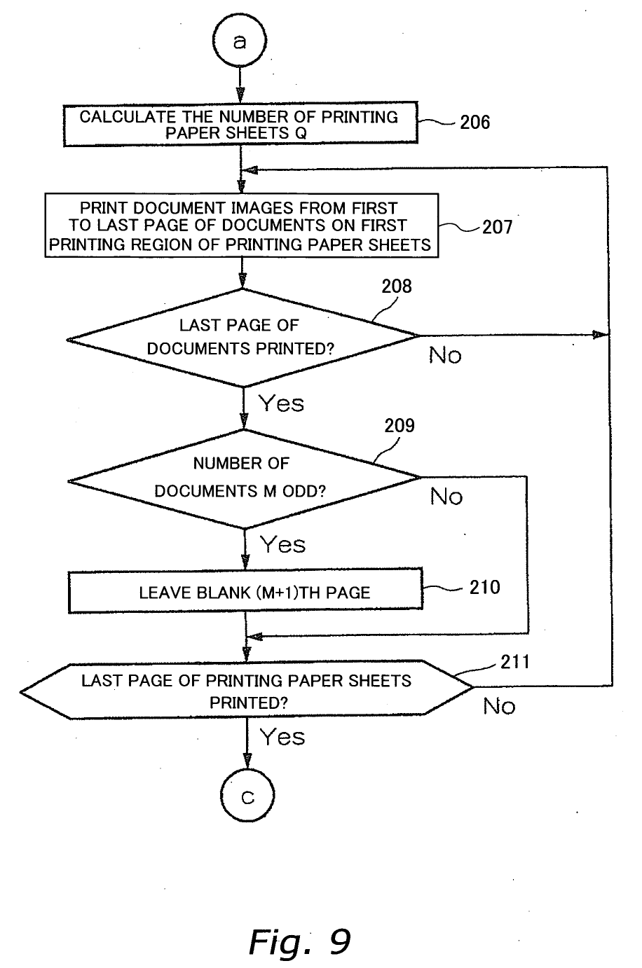

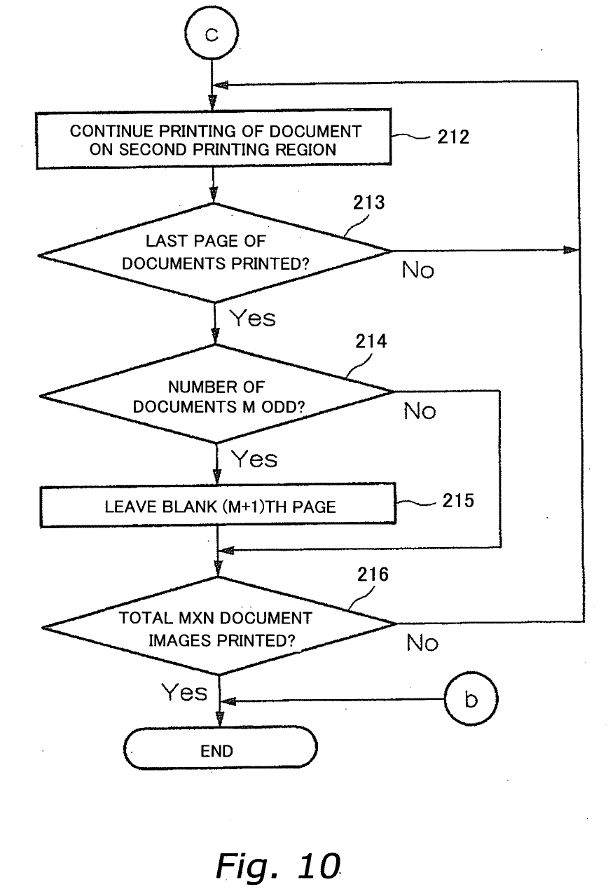

The operation of the image forming device according to the second embodiment of the present invention is explained next with reference to the flowcharts of FIG. 8 through FIG. 10. Operations in the constitution of FIG. 7 that have no direct connection with the present invention will not be explained herein. In these figures, the input unit 52 sets first the number of print copies of the documents, the printing paper size, the printing mode etc., as default settings, and instructs among others the start of the printing operation (Step 200), whereupon the document number counter 62 counts the number of documents placed on a platen not shown in the figure (Step 201).

Next, the document is read by the scanner 54 and is converted into digital document image data (Step 202); the document image data is then stored in the image memory 55 (Step 203). Next it is determined whether the input unit 52 has instructed printing or not (Step 204). If NO in Step 204, the same assessment is repeated. If YES in Step 204, it is then determined whether the designated printing mode is a combined printing mode or not (Step 205).

If NO in Step 205, other processes are performed (processes other than combined printing), (Step 213), and the printing operation is terminated.

If YES in Step 205, the number of printing paper sheets Q is then calculated on the basis of the number of documents M counted by the document number counter 62, the number of print copies N set by the input unit 52, and the number K of document images for combined printing on one printing paper sheet (Step 206).

Taking M as the number of documents (an integer ≧2), N as the number of print copies (an integer ≧2), and K as the number (an even number ≧2) of document images for combined printing on the same face of one printing paper sheet, the required number of printing paper sheets Q is calculated, when M is even, as Q=M×N/2K (if divisible) or Q={the quotient of (M×N/2K)}+1 (if not divisible); when M is odd, Q is calculated as Q=(M+1)×N/2K (if divisible) or Q={the quotient of (M+1)×N/K)}+1 (if not divisible).

In the present embodiment, the number of document images for combined printing on the same face of one printing paper sheet K is set to K=2, so that one side of one sheet of printing paper is divided into two printing regions, a first printing region P1 and a second printing region P2.

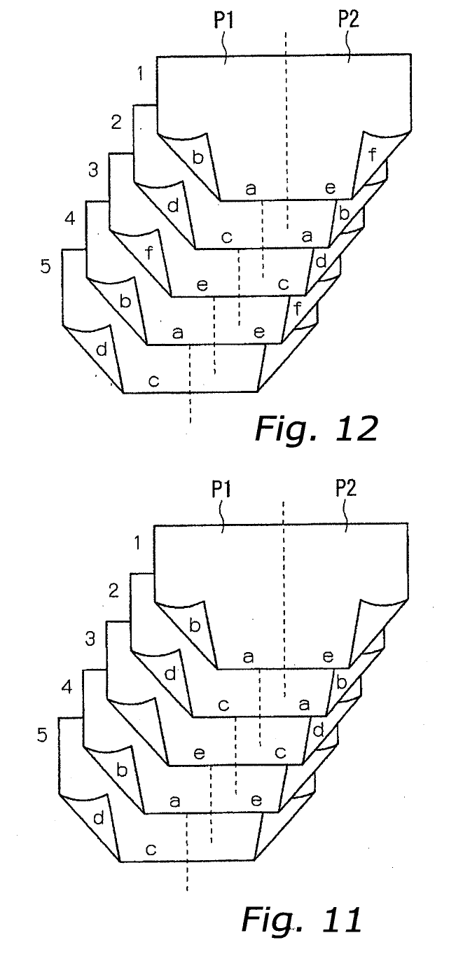

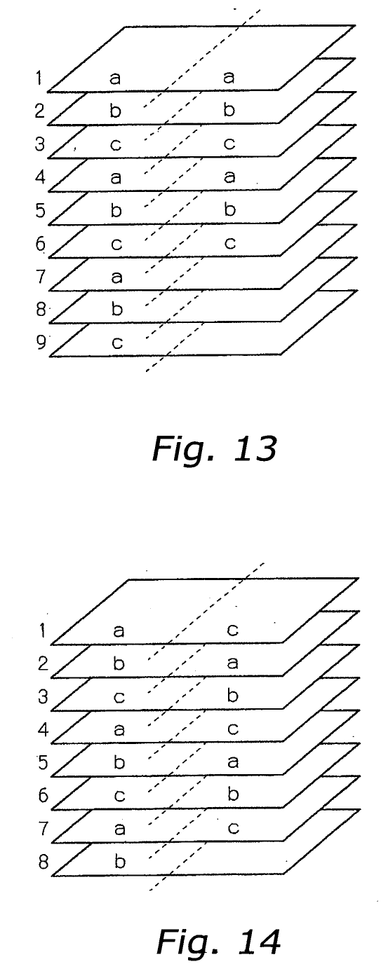

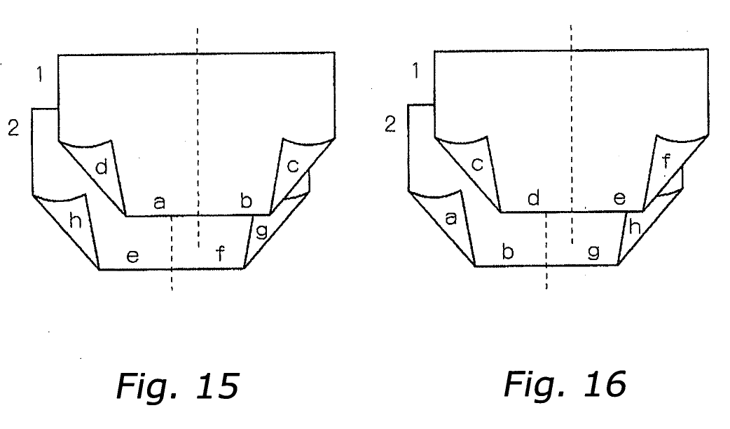

By way of example, let us assume that 3 copies each of 6 documents a, b, c, d, e, and f are to be combined-printed on both sides of printing paper, as shown in FIG. 11. In this case, M=6, N=3, K=2, so the printing index Q is Q=M×N/2K=6×¾=4 (quotient), remainder 2. Herein, therefore, Q=4+1=5.

For an odd number of documents, let us assume for instance that 3 copies each of 5 documents a, b, c, d and e are to be combined-printed on both sides of printing paper sheets, as shown in FIG. 12. In this case, M=5, N=3, K=2, so the printing index Q is Q=(M+1)×N/2K=6×¾=4 (quotient), remainder 2. In this case, therefore, Q=4+1=5.

After calculating the number of printing paper sheets Q, the document images are printed sequentially from the first to the last page of the document images, on a first printing region P1 on both sides of printing paper sheets 1 through 5, as shown in FIG. 11 or FIG. 12, (Step 207).

Next, the process determines whether the documents have been printed to the last document page (Step 208). If the documents have not been printed to the last page, the process returns to Step 207 to carry out the processing already described. If printing has been completed to the last page of the documents, the process determines, from the document count result of Step 201, whether the number of documents M is odd or not (Step 209).

When the number of documents M is odd, for instance when the document images of 5 documents a through e are printed, as shown in FIG. 12, the document image e is printed on the front face of the printing paper sheet 3, i.e. the fifth printing paper page (corresponding to the M-th printing paper page), while the back of the printing paper sheet 3, the sixth page (the (M+1)th printing paper page), is left blank (Step 210); the process proceeds then to Step 211.

If the number of documents M is even, the process proceeds to Step 211.

Next, in Step 211 the process determines whether the printing paper sheets have been printed to the last page. Herein, “last page” means the page corresponding to the back of the Q-th sheet, wherein Q is the number of printing paper sheets calculated from the number of documents M and the number of print copies N to be printed.

If NO in Step 211, the process returns to Step 207 and repeats the processing of steps 207 through 210. If YES in Step 211, printing of the document images continues on the second printing region P2 back on the first page of the printing paper sheets (Step 212). Next, the process determines whether the documents have been printed to the last page (Step 213). If the documents have not been printed to the last page, the process returns to Step 212 to carry out the processing already described.

If printing has been completed to the last page of the documents, the process determines, from the document count result of Step 201, whether the number of documents M to be printed is odd or not (Step 214).

If in Step 214 it is determined that the number of documents M is odd, the (M+1)th printing paper page is left blank, as explained above, (Step 215), then the process proceeds to Step 216.

If in Step 214 it is determined that the number of documents M is even, the process proceeds to Step 216.

Next, the process determines whether the total M×N document images have been printed or not (Step 216). If the document images have not been yet printed to the M×N total, the process returns to Step 212 to repeat the processing already described. The printing operation ends when the total M×N document images have been printed.

Once the above printing is over, the printed paper sheets are cut along the broken lines indicated by the arrows in FIGS. 11, 12, using auxiliary equipment of the image forming device, so as to separate the printing regions P1 and P2 along the center of the printing paper sheets; the required number of copies of the printed printing paper sheets can then be automatically sorted, with the document images in the document page order, for instance (abcde)→(abcde)→(abcde) as shown in FIG. 12, by stacking the last page of the cut printing paper sheets of the left onto the uppermost cut printing paper sheet of the right. The cutting and stacking of the printed product can also be done by the user.

What is claimed is:

1. An image forming device having a combined printing function for printing a plurality of document images on a same face of one printing paper sheet, comprising:
printing means for printing document images acquired by document reading in accordance with a number of documents and a number of print copies; and
control means for calculating a number of necessary printing paper sheets on the basis of the number of documents, the number of print copies, and a number of document images for combined printing on one printing paper sheet, and for controlling the printing means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document.

2. An image forming device having a combined printing function for printing a plurality of document images on a same face of one printing paper sheet, comprising
input means for designating settings such as number of document print copies, printing paper size, printing mode or the like, and for instructing among others a start of a printing operation;
counting means for counting the number of set documents;
document reading means for reading document images;
image data storing means for storing document image data read by the document reading means;
printing means for reading the document image data from the image data storing means and for printing the document image data on printing paper;
computation means for, if the set printing mode when printing is instructed by the input means is a combined printing mode, computing the number of printing paper sheets on the basis of the number of documents counted by the counting means, the number of print copies set by the input means, and a number of document images for combined printing on one printing paper sheet; and
control means for controlling the printing means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, wherein if by a last page of the printing paper sheets there remain not enough printing paper sheets for printing the number of print copies of a same document image, printing continues on another printing region, being a next printing region in a printing sequence, returning to the first page of the printing paper sheets to print the number of copies of the document images of the last page of the document.

3. An image forming device according to claim 2, wherein the computation means calculates the necessary number of printing paper sheets Q as Q=M×N/K, if M×N is even (M×N being an integer ≧2), and Q={the quotient of (M×N/K)}+1, if M×N is odd, wherein M is a number of documents, N is a number of print copies, and K is a number (an even number ≧2) of document images for combined printing on the same face of one printing paper sheet, and wherein
if M×N is odd, the control means controls the printing means so as to leave (K-L) blank printing regions on the last page of the printing paper sheets after printing all the print copies of the document images, L being the remainder of M×N/K.

4. An image forming device according to claim 2, having a selectable first printing mode in which, when combined printing is set as the printing mode, combined printing is carried out by consecutively printing the number of print copies for each page of the document on one printing region among a plurality thereof into which one face of one printing paper sheet is divided, in a number of printing paper sheets according to the number of document print copies; and having
a selectable second printing mode in which combined printing is consecutively carried out on all the pages of the document, in the page order of the document, as 1 set, for the number of print copies (number of sets), on one printing region among a plurality thereof into which one face of one printing paper sheet is divided, in a number of printing paper sheets according to the number of document print copies.

5. A control method for an image forming device having a combined printing function for printing a plurality of document images on a same face of one printing paper sheet, comprising the steps of
calculating a number of necessary printing paper sheets on the basis of the number of documents, the number of print copies, and a number of document images for combined printing on one printing paper sheet;
printing the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies; and
continuing printing on another printing region, being a next printing region in a printing sequence, if by a last page of the printing paper sheets there remain not enough printing paper sheets for printing the number of print copies of a same document image, returning to the first page of the printing paper sheets to print the number of copies of the document images of the last page of the document.

6. A control method for an image forming device having a combined printing function for printing a plurality of document images on a same face of one printing paper sheet, comprising the steps of
inputting settings such as number of document print copies, printing paper size, printing mode or the like, and for instructing among others a start of a printing operation, by way of input means;
counting the number of set documents by way of counting means;
reading document images by way of document reading means;
storing document image data read by the document reading means by way of image data storing means;
calculating the number of printing paper sheets on the basis of the number of documents counted by the counting means, the number of print copies set by the input means, and a number of document images for combined printing on one printing paper sheet, if the set printing mode when printing is instructed by the input means is a combined printing mode;
calculating, by way of computation means, the number of printing paper sheets on the basis of the number of documents counted by the counting means, the number of print copies set by the input means, and a number of document images for combined printing on one printing paper sheet, if the set printing mode when printing is instructed by the input means is a combined printing mode; and
controlling the printing means by way of control means so as to print the document images on the same face of printing paper sheets for the calculated number of plural printing paper sheets, on a printing region partitioned beforehand, following a pre-established printing order from a first to a last page of the document, each page of the document being printed on a same printing region, being a first printing region in a printing sequence, from a first page of the plural printing paper sheets and for a number of pages corresponding to the number of print copies, and so as to continue printing on another printing region, being a next printing region in a printing sequence, if by a last page of the printing paper sheets there remain not enough printing paper sheets for printing the number of print copies of a same document image, returning to the first page of the printing paper sheets to print the number of copies of the document images of the last page of the document.

7. A control method for an image forming device according to claim 6, wherein the computation means calculates the necessary number of printing paper sheets Q as Q=M×N/K, if M×N is even (M×N being an integer ≧2), and Q={the quotient of (M×N/K)}+1, if M×N is odd, wherein M is a number of documents, N is a number of print copies, and K is a number (an even number ≧2) of document images for combined printing on the same face of one printing paper sheet; and wherein
if M×N is odd, the control means controls the printing means so as to leave (K-L) blank printing regions on the last page of the printing paper sheets after printing all the print copies of the document images, L being the remainder of M×N/K.

8. An image forming device having a combined printing function for printing a plurality of document images on both faces of one printing paper sheet, comprising
printing means for printing document images acquired by document reading in accordance with a number of documents and a number of print copies; and
control means for calculating a number of necessary printing paper sheets on the basis of the number of documents, the number of print copies, and a number of document images for combined printing on one printing paper sheet, and for controlling the printing means so as to repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, wherein upon reaching a last page of the plurality of printing paper sheets, printing continues returning to the first page of the plurality of printing paper sheets, on a next printing region in a printing order, until printing the number of print copies of the plurality of document images, for each printing region of the plurality thereof.

9. An image forming device having a combined printing function for printing a plurality of document images on both faces of one printing paper sheet, comprising
input means for designating settings such as number of document print copies, printing paper size, printing mode or the like, and for instructing among others a start of a printing operation;
counting means for counting the number of set documents;
document reading means for reading document images;
image data storing means for storing document image data read by the document reading means;
printing means for reading the document image data from the image data storing means and for printing the document image data on printing paper;
computation means for, if the set printing mode when printing is instructed by the input means is a combined printing mode, computing the number of printing paper sheets on the basis of the number of documents counted by the counting means, the number of print copies set by the input means, and a number of document images for combined printing on one printing paper sheet; and
control means for controlling the printing means so as to repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, wherein upon reaching a last page of the plurality of printing paper sheets, printing continues returning to the first page of the plurality of printing paper sheets, on a next printing region in a printing order, until printing the number of copies of the plurality of document images, for each printing region of the plurality thereof.

10. An image forming device according to claim 9, wherein the computation means calculates the necessary number of printing paper sheets Q as Q=M×N/2K (if divisible) or Q={the quotient of (M×N/2K)}+1 when M is even, and as Q=(M+1)×N/2K (if divisible) or Q={the quotient of (M+1)×N/K)}+1 when M is odd, M being a number of documents (an integer ≧2), N a number of print copies (an integer ≧2), and K a number (an even number ≧2) of document images for combined printing on the same face of one printing paper sheet, and wherein
when M is odd, the control means controls the printing means so as to leave blank the printing region of a (M+1)th page following M pages where document images of each document have been printed on the printing paper sheets.

11. A control method for an image forming device having a combined printing function for printing a plurality of document images on both faces of one printing paper sheet, comprising the steps of
calculating a number of necessary printing paper sheets on the basis of the number of documents, the number of print copies, and a number of document images for combined printing on one printing paper sheet;
repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand; and
continuing printing, upon reaching the last page of the plurality of printing paper sheets, returning to the first page of the plurality of printing paper sheets, on a next printing region in a printing order, until printing the number of copies of the plurality of document images, for each printing region of the plurality thereof.

12. A control method for an image forming device having a combined printing function for printing a plurality of document images on both faces of one printing paper sheet, comprising
inputting settings such as number of document print copies, printing paper size, printing mode or the like, and for instructing among others a start of a printing operation, by way of input means;
counting the number of set documents by way of counting means;
reading document images by way of document reading means;
storing document image data read by the document reading means by way of an image data storing means;
calculating, by way of computation means, the number of printing paper sheets on the basis of the number of documents counted by the counting means, the number of print copies set by the input means, and a number of document images for combined printing on one printing paper sheet, if the set printing mode when printing is instructed by the input means is a combined printing mode; and
controlling the printing means by way of control means so as to repeatedly and sequentially printing document images from a first to a last page of a plurality of documents, in a pre-established printing order from a first page of a plurality of printing paper sheets, one such page being respectively the front and back face of each printing paper sheet, for the calculated number of printing paper sheets, onto one printing region of a plurality thereof into which each of both faces of one printing paper sheet is divided so that front and back faces are superposed beforehand, and so as to continue printing, upon reaching the last page of the plurality of printing paper sheets, returning to the first page of the plurality of printing paper sheets, on a next printing region in a printing order, until printing the number of print copies of the plurality of document images, for each printing region of the plurality thereof.

13. A control method for an image forming device according to claim 12, wherein the computation means calculates the necessary number of printing paper sheets Q as Q=M×N/2K (if divisible) or Q={the quotient of (M×N/2K)}+1 when M is even, and as Q=(M+1)×N/2K (if divisible) or Q={the quotient of (M+1)×N/K)}+1 when M is odd, M being a number of documents (an integer ≧2), N a number of print copies (an integer ≧2), and K a number (an even number ≧2) of document images for combined printing on the same face of one printing paper sheet; and wherein
when M is odd, the control means controls the printing means so as to leave blank the printing region of a (M+1)th page following M pages where document images of each document have been printed on the printing paper sheets.
